(19) United States
(12) Patent Application Publication
(10) Pub. No.: US 2008/0094246 A1
(43) Pub. Date: Apr. 24, 2008

(54) AUTO TURN-ON MODULE AND PLAYER APPARATUS AND METHOD FOR TURNING ON A SYSTEM AUTOMATICALLY

(75) Inventor: Cheng-Chih Yuan, Taipei (TW)

Correspondence Address: KIRTON AND MCCONKIE, 60 EAST SOUTH TEMPLE,, SUITE 1800, SALT LAKE CITY, UT, 84111, US

(73) Assignee: VIA TECHNOLOGIES, INC., Taipei (TW)

(21) Appl. No.: 11/563,580

(22) Filed: Nov. 27, 2006

(30) Foreign Application Priority Data
Oct. 4, 2006 (TW) 095136969

(51) Int. Cl. G05B 19/02; G08B 1/00

(52) U.S. Cl. 340/825.22; 340/825.24; 713/300; 340/309.16

(57) ABSTRACT

An auto turn-on module at least includes a timer, a logic unit and a memory unit. The timer provides real time data. The logic unit is electronically connected with the timer and has a register, wherein the register stores a state indicator data therein. The memory unit is electronically connected with the logic unit and stores therein a turn-on schedule data. If the real time data and the turn-on schedule data are the same after being compared, a turn-on signal is generated from the logic unit, and the state indicator data stored in the register is changed according to the turn-on schedule data.

### FIELD OF THE INVENTION

The present invention relates to a turn-on module and a method for turning on a system. More particularly, the present invention relates to an auto turn-on module, a method for turning on a system automatically. The present invention also relates to a player apparatus capable of being automatically turned on.

### BACKGROUND OF THE INVENTION

Generally, a computer is turned on manually, so some limitations may exist. For example, if people want to have a computer turned on at specific time, he has to appear in front of the computer and press on the power button of the computer at that time exactly to run the computer. It would be particularly troublesome when the computer needs to be turned on regularly. For current technology, people may set a time event in a basic input output system (BIOS) to solve the problem mentioned above, but it is applicable to limited types of computers only. Also, there is no standard interface adopted by these computers, so it is not user-friendly. Besides, there is only one time event able to be set in BIOS, and the setting of the time event cannot be flexibly done by way of software.

On the other hand, with technology development, some plane media has been gradually replaced by electronic media such as a digital signage or a kiosk. For example, a digital signage is commonly disposed on a street for promotion purposes, and a kiosk is commonly used in an information center to provide searching services for travellers. Using a digital signage to broadcast information could reach promotion purpose, but is not as good as expected after midnight as few people would stay outside and watch it then. Therefore, in order to save energy, power of digital signage is generally turned off at midnight, and then turned on again in the morning. Likewise, using a kiosk in an information center could reduce manpower cost, and it is necessary to turn off the power of the kiosk after office hours and then turn it on again at the beginning of office hours to save energy and extend the machine lifespan. As the power states of the digital signage or the kiosk are conventionally manipulated by people, some problems may happen due to operators' mistakes. For example, operators may be late for work so that the digital signage cannot be timely turned on or the apparatus is made to run day and night so that energy waste and energy cost increase.

### SUMMARY OF THE INVENTION

The invention provides an auto turn-on module. The auto turn-on module at least includes a timer, a logic unit and a memory unit. The timer provides real time data. The logic unit is electronically connected with the timer and has a register, wherein the register stored therein a state indicator data. The memory unit is electronically connected with the logic unit and stored therein a turn-on schedule data. If the real time data and the turn-on schedule data conform to each other after being compared in the logic unit, a turn-on signal is generated from the logic unit, and the state indicator data stored in the register is changed according to the turn-on schedule data.

The invention provides a player apparatus. The player apparatus at least includes a player system and an auto turn-on module electronically connected with the player system. The auto turn-on module includes a timer, a logic unit and a memory unit. The timer provides real time data. The logic unit is electronically connected with the timer and has a register, wherein the register stored therein a state indicator data. The memory unit is electronically connected with the logic unit and stores therein a turn-on schedule data. If the real time data and the turn-on data conform to each other after being compared in the logic unit, a turn-on signal is generated from the logic unit and then transmitted to the player system, and the state indicator data stored in the register is changed according to the turn-on schedule data.

The invention provides a method for turning on a system automatically. First, whether a state of a main power is a turn-off state is checked. Real time data and turn-on schedule data are obtained from a timer and a memory unit respectively, and then compared in the logic unit. If the real time data and the turn-on schedule data conform to each other, a turn-on signal is generated from the logic unit, and the state indicator data stored in the register is changed according to the turn-on schedule data.

### BRIEF DESCRIPTION OF THE DRAWINGS

The accompanying drawings are included to provide further understanding of the invention, and are incorporated in and constitute a part of this specification. The drawings illustrate embodiments of the invention and, together with the description, serve to explain the principles of the invention.

FIG. 1 is a functional block diagram showing a computer system having an auto turn-on module according to an embodiment of the present invention.

FIG. 2 is a functional block diagram showing an auto turn-on module according to an embodiment of the present invention.

FIG. 3 is a functional block diagram showing an auto turn-on module according to another embodiment of the present invention.

FIG. 4 is a functional block diagram showing a player apparatus according to an embodiment of the present invention.

FIG. 5 is a functional block diagram showing a player apparatus according to another embodiment of the present invention.

FIG. 6 is a flowchart of a method for turning on a system automatically according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

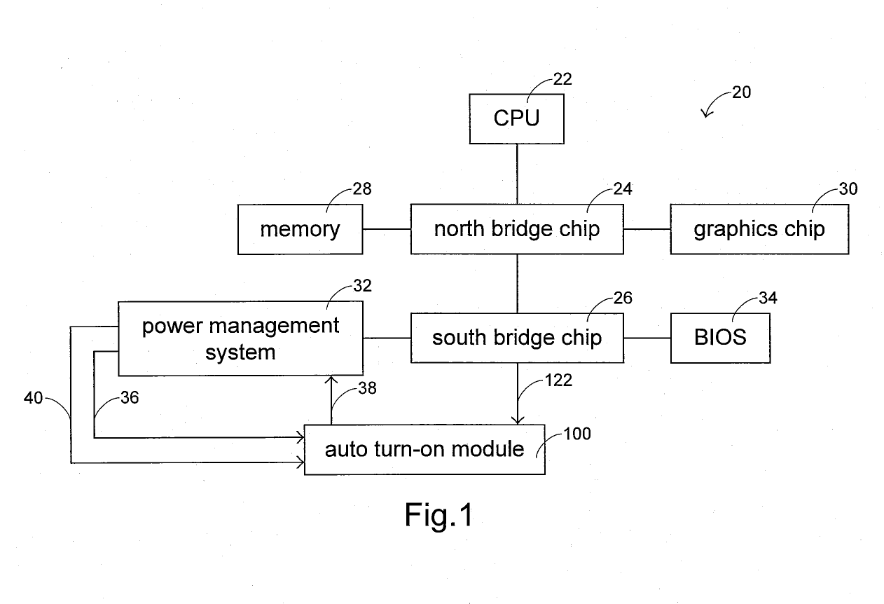

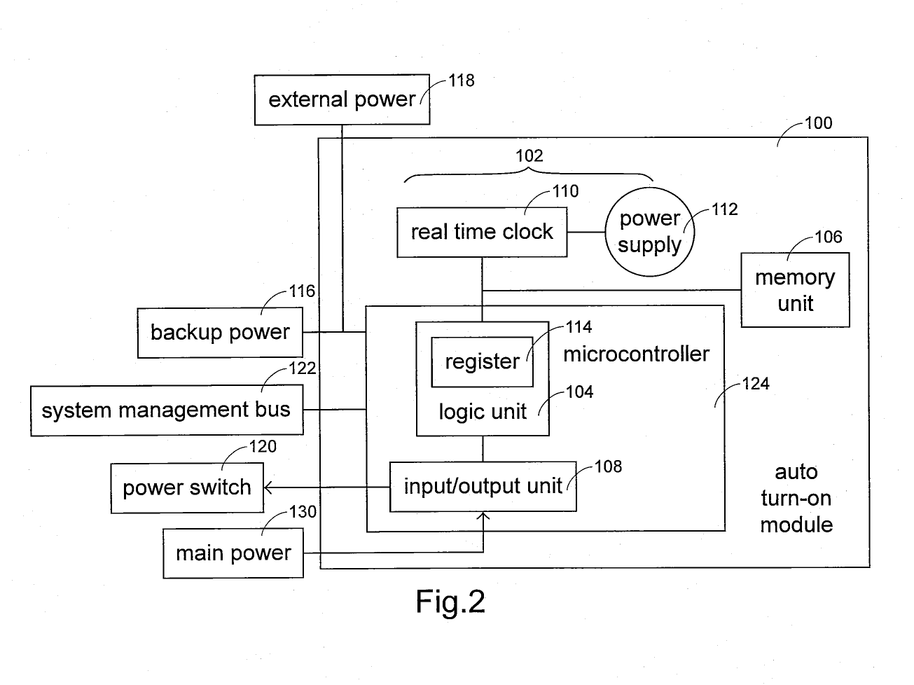

FIG. 1 is a functional block diagram showing a computer system having an auto turn-on module according to an embodiment of the present invention. FIG. 2 is a functional block diagram showing an auto turn-on module according to an embodiment of the present invention. Referring to FIGS. 1 and 2, a computer system 20 at least includes a central processing unit (CPU) 22, a north bridge chip 24, a south bridge chip 26, a memory 28, a graphics chip 30, a power management system 32, a BIOS 34 and an auto turn-on module 100. The north bridge chip 24 is a control chip and electronically connected with the CPU 22, the memory 28 and the graphics chip 30. The south bridge chip 26 is also a control chip and electronically connected with the power management system 32, the BIOS 34 and the auto turn-on module 100. Furthermore, the power management system 32 is used to manage a signal 36 outputted from a backup power 116 to the auto turn-on module 100, a signal 38 outputted from the auto turn-on module 100 to a power switch 120 and a signal 40 outputted from a main power 130 to the auto turn-on module 100 (FIG. 2). It is noted that while the BIOS 34, which can be used to set one turn-on time event as described above, is electronically connected with the south bridge chip 26 via low pin count bus (LPC bus), the auto turn-on module 100, which allows at least two turn-on time events to be set, is electronically connected with the south bridge chip 26 via a system management bus (SM bus) 122.

Hereinafter, the auto turn-on module 100 of the invention will be illustrated in detail. Referring to FIG. 2, the auto turn-on module 100 at least includes a timer 102, a logic unit 104 and a memory unit 106. In a preferred embodiment, the auto turn-on module 100 further includes an input/output unit (I/O Unit) 108.

The timer 102 is used to generate real time data. In a preferred embodiment, the timer 102 comprises of a real time clock (RTC) 110 and a power supply 112, wherein the power supply 112 may be a battery, for example. Particularly, the real time data from the RTC 110 is obtained by generating a clock signal by an oscillator and dividing frequency of the clock signal. Furthermore, the power supply 112 is used to keep the RTC 110 running.

The logic unit 104 is electronically connected with the timer 102 and includes a register 114, wherein the register 114 stores therein a state indicator data. The logic unit 104 functions like a CPU for dealing with data, and keeps running with the backup power 116 or external power 118 that operates for protecting circuit.

The memory unit 106 is electronically connected with the logic unit 104 and stores therein a turn-on schedule data. The memory unit 106 may be an electrically erasable programmable read only memory (EEPROM), for example, so that the turn-on schedule data stored therein would not disappear after power is turned off. It is noted that a turn-on time event, such as at 7 A.M. today or at 8 P.M. every Monday, can be preset by way of software design and stored in the memory unit 106. In a preferred embodiment, at least two turn-on time events, such as at 7 A.M. today and at 8 P.M. every Monday, can be stored in the memory unit 106 at the same time.

Particularly, if the real time data of the timer 102 and the turn-on schedule data of the memory unit 106 are the same after being compared in the logic unit 104, a turn-on signal is generated from the logic unit 104 to turn on the power switch 120, and meanwhile, the state indicator data in the register 114 is changed. In a preferred embodiment, the turn-on signal may be transmitted to the power switch 120 via the I/O unit 108. For example, the state indicator data stored in the register 114 varies with different time events. For example, the state is changed from an initial state to a state representing the turn-on time event at 7 A.M. today. Alternatively, the state representing the turn-on time event at 7 A.M. today may further be changed to another state representing a turn-on time event at 8 P.M. every Monday. Accordingly, users can realize why the power switch 120 is turned on according to the state data recorded in the register 114.

In a preferred embodiment, the auto turn-on module 100 of the present invention may communicate with an external device via the SM bus 122 so that the turn-on schedule data can be written into the memory unit 106 via the SM bus 122. Particularly, the SM bus 122 is a standard interface adapted to a computer system. It means the auto turn-on module 100 of the present invention needs no additional interface to communicate with the external, so the data input can be easily implemented and the apparatus cost can be reduced.

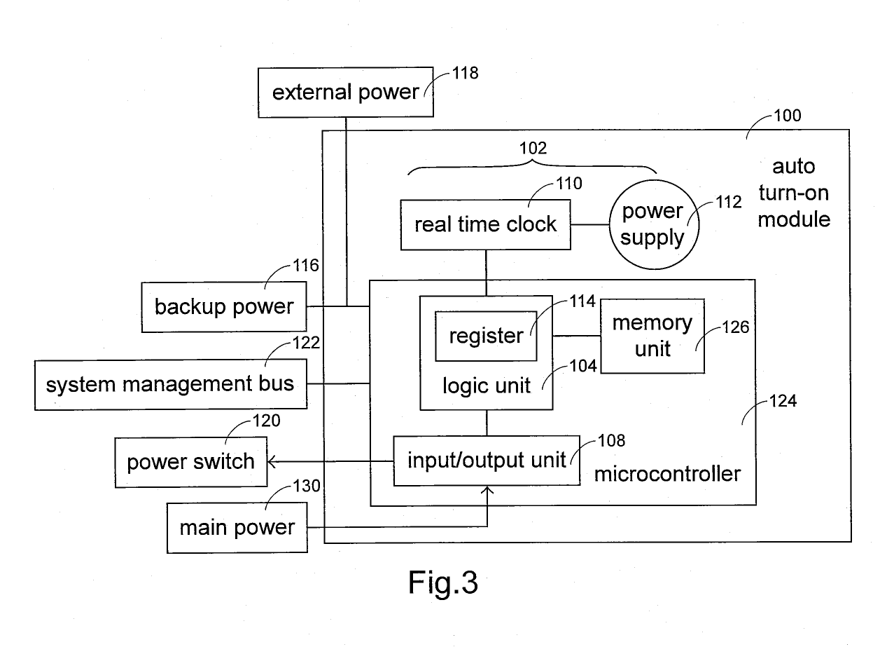

In a preferred embodiment, the logic unit 104 and the I/O unit 108 may be incorporated in a microcontroller 124. In another preferred embodiment, the memory unit 106 can be replaced with a memory unit 126, as shown in FIG. 3, so that the logic unit 104, the I/O unit 108 and the memory unit 126 are all disposed in the microcontroller 124. In other words, the memory unit 126 is one of the components of the microcontroller 124, and can additionally store instructions for operating the microcontroller 124. The turn-on schedule data can be arbitrarily stored in the memory unit 106 or 126 as long as the capacity of the memory unit is large enough. Furthermore, the whole auto turn-on module can be designed as a System-on-Chip (SOC).

Accordingly, due to the disposition of the register 114 in the auto turn-on module of the present invention, why a power switch is turned on can be realized. Compared with setting single turn-on data in the BIOS in the prior art, at least two turn-on time events can be stored in the memory unit of the auto turn-on module of the present invention. Moreover, the turn-on schedule data can be inputted and stored in the auto turn-on module of the present invention via a standard interface, such as a SM bus, so it is easy to operate, and apparatus cost can be reduced.

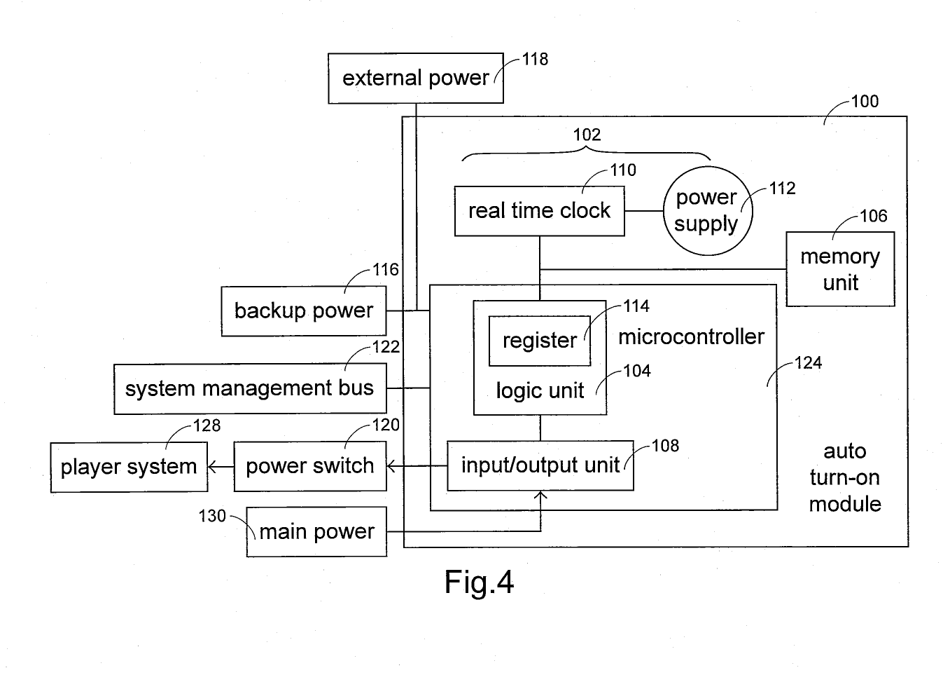

It is noted that the auto turn-on module of the present invention is not to be limited in turning on a computer system, while it has other application fields. For example, the auto turn-on module 100 can be used in a player apparatus, such as an auto teller machine (ATM), a digital signage, a kiosk or a gaming machine. In detail, the player apparatus at least includes a player system 128 and the auto turn-on module 100 is connected therewith, as shown in FIG. 4. If real time data of timer 102 and turn-on schedule data of logic unit 104 are the same after being compared in the logic unit 104, a turn-on signal will be generated from the logic unit 104 to turn on the power switch 120 via the I/O unit 108. Furthermore, after the power switch 120 is turned on, the turn-on signal can be transmitted to the player system 128 to turn on the player apparatus.

Moreover, the state indicator data stored in the register 114 may be changed with different turn-on time events stored in the memory unit 106, so that why a player apparatus is turned on can be realized. In a preferred embodiment, the state indicator data in the register 114 may be referenced to execute other instructions. For example, users may set “7 A.M. on Monday” as a first turn-on schedule data, and there will be a first program scheduled to be broadcasted at that time. The user further sets “7 A.M. on Tuesday” as a second turn-on schedule data, and there will be a second program scheduled to be broadcasted at that time. When real time data in the timer 102 of the player apparatus and the first turn-on schedule data, i.e. 7 A.M. on Monday, are the same, the state indicator data in the register 114 is changed to a first state indicator data, and then the player apparatus is turned on. In detail, the first state indicator data relates to a specific one of the turn-on time events, i.e. the first turn-on schedule data, so after the player apparatus is turned on, the first program will be broadcasted at 7 A.M. on Monday according to the first state indicator data. Similarly, when real time data in the timer 102 of the player apparatus and the second turn-on schedule data, i.e. 7 A.M. on Tuesday, are the same, the state recorded in the register 114 will be changed from the first state indicator data into the second state indicator data. Since the second state indicator data relates to another specific one of the time events of the turn-on schedule data, the second program will be broadcasted at 7 A.M. on Tuesday according to the second state indicator data.

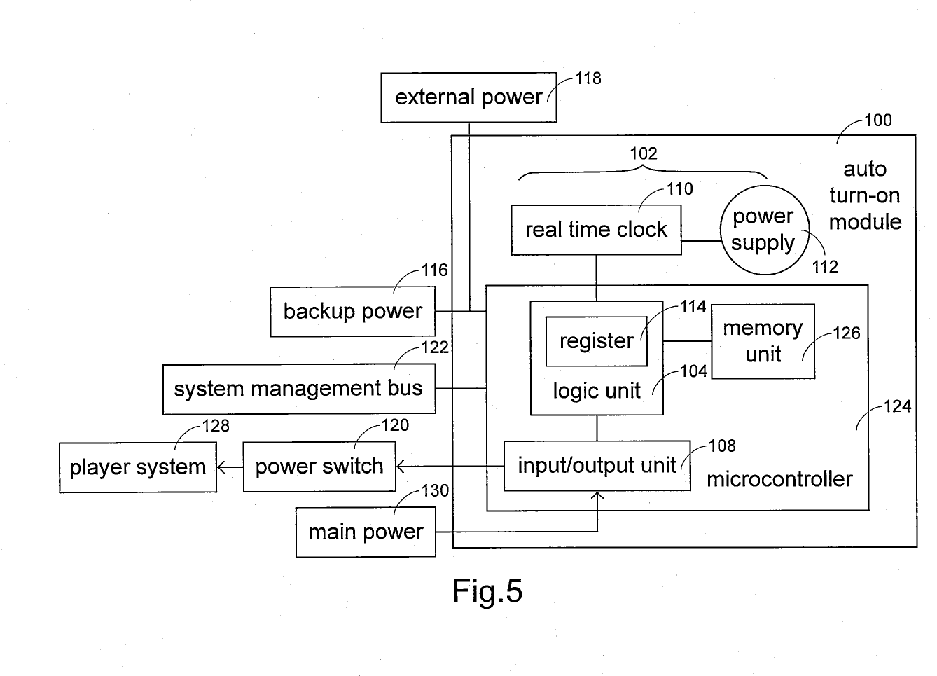

Similar to the above embodiments, the logic unit 104 and the I/O unit 108 may be components of the microcontroller 124. Alternatively, the memory unit 106 is replaced with the memory unit 126, as shown in FIG. 5, and the logic unit 104, the I/O unit 108 and the memory unit 126 may be incorporated in the microcontroller 124.

Accordingly, besides the advantages mentioned above, applying the present invention in a player apparatus can avoid people from making mistake, such as delay problems, and reduce manpower cost as well.

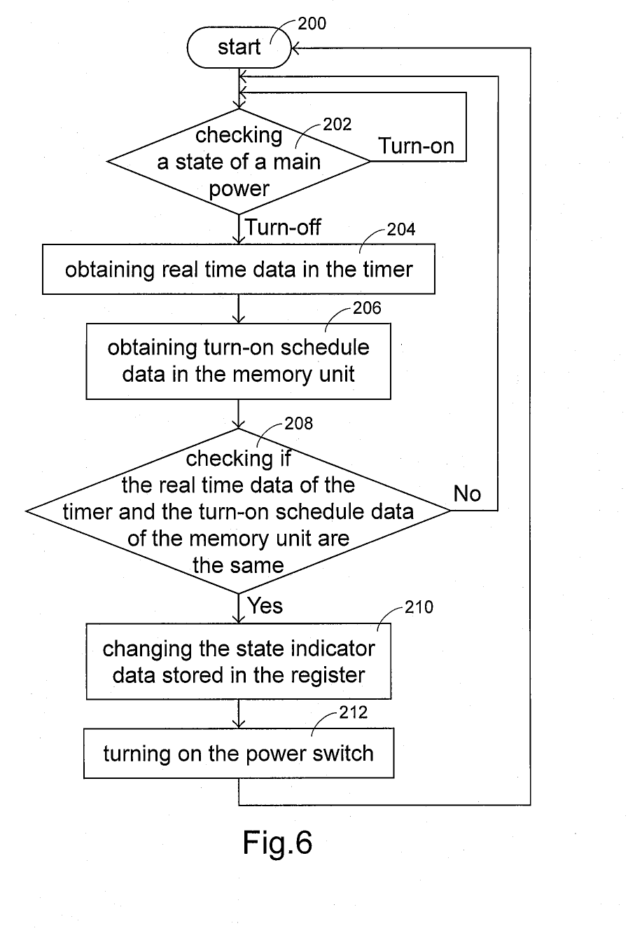

Hereinafter, a method for turning on a system automatically according to the present invention will be illustrated by referring to the flowchart of FIG. 6 and the functional block diagram of FIG. 2 or 3.

Referring to FIGS. 2, 3 and 6, if there is the auto turn-on module 100 of the present invention disposed in a system, the flowing steps can be performed (Step 200). First, a step 202 of checking a state of the main power 130 is performed. If the main power 130 has been transmitted to the auto turn-on module 100 via the I/O unit 108 in step 202, subsequent steps will be skipped. In detail, if the main power 130 has been turned on, but still restarts via the following steps, the computer system may perform mistake instructions. In other cases, although the computer system may perform correct instructions, the temporary state in register 114 will be changed to be another temporary state, so that operators may obtain wrong information because of restarting the computer system. On the other hand, if the main power is in a turn-off state, whether the power switch 120 should be turned on is determined according to the following steps.

First of all, steps 204 and 206 are performed for obtaining real time data in the timer 102 and turn-on schedule data in the memory unit 106 (FIG. 2) or 126 (FIG. 3). In a preferred embodiment, at least two turn-on time events, e.g. turning the system on at 7 A.M. today and at 8 P.M. every Monday, are stored in the memory unit 106 or 126 at the same time.

Thereafter, a step 208 is performed for comparing the real time data of the timer 102 and the turn-on schedule data of the memory unit 106 or 126. If the real time data of the timer 102 and the turn-on schedule data of the memory unit 106 or 126 are different, which means it has not yet been the time to turn on the system, the next step will go back to step 202 and then perform steps 204-208 again. On the other hand, if the real time data of the timer 102 and the turn-on schedule data of the memory unit 106 or 126 are the same, which means it is the time to turn on the system, the flow will go further to step 210.

After checking the real time data of the timer 102 and the turn-on schedule data of the memory unit 106 or 126 and confirming they are the same, steps 210 and 212 are performed for generating a turn-on signal to turn on the power switch 120. Meanwhile, the state indicator data stored in the register 114 of the logic unit 104 is changed. The turn-on signal is generated from the logic unit 104 to turn on the power switch 120 via the I/O unit 108. Particularly, in the present invention, the state indicator data in the register 114 varies with different turn-on time events stored in the memory unit 106 or 126. As a result, why the system is turned on can be realized. For example, users may set “7 A.M. on Monday” as a first turn-on schedule data and “7 A.M. on Tuesday” as a second turn-on schedule data. If real time data of timer 102 is the same as the first turn-on schedule data, the state indicator data in the register 114 will be changed to a first state indicator data to turn on the computer system at 7 A.M. on Monday. Therefore, people could realize that the computer system was turned on because of the first turn-on schedule data, i.e. 7 A.M. on Monday, according to the first state indicator data. Similarly, when real time data of timer 102 is the same with the second turn-on schedule data, the state in the register 114 may be changed from the first state indicator data to a second state indicator data to turn on the computer system at 7 A.M. on Tuesday. Therefore, people could realize that the computer system was turned on because of the second turn-on schedule data, i.e. 7 A.M. on Tuesday, according to the second state indicator data.

Furthermore, regarding to the input of turn-on time data in the memory unit 106 or 126, it can be implemented by operating a computer directly, or getting controlled remotely, e.g. via internet. Therefore, the data input way is flexible. Moreover, instead of setting by the user, a plurality of turn-on time events can also be preset and pre-stored in a memory unit via software by the manufacturer.

It is noted the method for turning on a system automatically according to the present invention is not to be limited in turning on a computer system, while it has other application fields. For example, the method of the present invention can be used in a player apparatus, such as an ATM, a kiosk, a digital signage or a gaming machine. It means the player apparatus can be automatically turned on by performing the steps mentioned above. For example, if the real time data of the timer 102 and the turn-on schedule data of the memory unit 106 or 126 are determined the same in the step 208 of FIG. 6, a turn-on signal is generated from the logic unit 104 to turn on the power switch 120 via the I/O unit 108. Also, after the power switch 120 is turned on, the turn-on signal is transmitted to the player system 128 of FIG. 4 or 5 to turn on the player apparatus. Therefore, the player apparatus, such as ATM, digital signage, kiosk or gaming machine, can be turned on at specific time. Also, applying the present method to turn on the player apparatus can avoid people from making mistake, such as delay problems. Moreover, the state indicator data stored in the register 114 may be changed with different turn-on time events stored in the memory unit 106 or 126, so that why a player apparatus is turned on can be realized. In a preferred embodiment, the state indicator data stored in the register 114 may be referenced to execute other instructions. For example, the user may set “7 A.M. on Monday” as a first turn-on schedule data, and there is a first program scheduled to be broadcasted at that time. Moreover, the user may set “7 A.M. on Tuesday” as a second turn-on schedule data, and there is a second program scheduled to be broadcasted at that time. When real time data in the timer 102 of the player apparatus and the first turn-on schedule data, i.e. 7 A.M. on Monday, are the same, the state indicator data in the register 114 is changed to the first state indicator data to turn on the player apparatus at 7 A.M. on Monday. In detail, the first state indicator data relates to a specific one of the turn-on time events, i.e. the first turn-on schedule data, so that after the player apparatus is turned on, the first program is broadcasted according to the first state indicator data. Similarly, when real time data in the timer 102 of the player apparatus and the second turn-on schedule data, i.e. 7 A.M. on Tuesday, are the same, the first state indicator data stored in the register 114 is replaced with the second state indicator data. Since the second state indicator data relates to another specific one of the turn-on time events, the second program will be broadcasted at 7 A.M. on Tuesday according to the second state indicator data.

Accordingly, besides the advantages mentioned above, applying the present method to a player apparatus can avoid people from making mistake, such as delay problems, and reduce manpower cost as well.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An auto turn-on module, at least comprising:
a timer generating real time data;
a logic unit electronically connected with the timer and having a register, wherein the register stored therein a state indicator data; and
a memory unit electronically connected with the logic unit and storing therein a turn-on schedule data,
wherein if the real time data and the turn-on schedule data conform to each other after being compared in the logic unit, a turn-on signal is generated from the logic unit, and the state indicator data stored in the register is changed according to the turn-on schedule data.

2. The auto turn-on module according to claim 1, wherein the turn-on schedule data includes at least two turn-on time events.

3. The auto turn-on module according to claim 1, wherein the turn-on schedule data is inputted from an external device via a system management bus.

4. The auto turn-on module according to claim 1, wherein the timer comprises a real time clock and a power supply.

5. The auto turn-on module according to claim 1, further comprising an input/output unit (I/O Unit) electronically connected with the logic unit, wherein when the real time data and the turn-on schedule data are the same, the I/O unit receives the turn-on signal from the logic unit and then outputs the turn-on signal.

6. A player apparatus, at least comprising:
a player system; and
an auto turn-on module electronically connected with the player system, the auto turn-on module comprising:
a timer generating real time data;
a logic unit electronically connected with the timer and having a register, wherein the register stores therein a state indicator data; and
a memory unit electronically connected with the logic unit and storing therein a turn-on schedule data,
wherein if the real time data and the turn-on schedule data conform to each other after being compared in the logic unit, a turn-on signal is generated from the logic unit and then transmitted to the player system, and the state indicator data stored in the register is changed according to the turn-on schedule data.

7. The player apparatus according to claim 6, wherein the player apparatus comprises an auto teller machine (ATM), a digital signage, a kiosk or a gaming machine.

8. The player apparatus according to claim 6, wherein the turn-on schedule data includes at least two turn-on time events.

9. The player apparatus according to claim 6, wherein the auto turn-on module is electronically connected to the external via a system management bus.

10. The player apparatus according to claim 6, wherein the timer comprises a real time clock and a power supply.

11. The player apparatus according to claim 6, further comprising an I/O unit electronically connected with the logic unit, wherein when the real time data and the turn-on schedule data are the same, the I/O unit receives the turn-on signal from the logic unit and then outputs the turn-on signal.

12. A method for turning on a system automatically, comprising:
checking whether a state of a main power is a turn-off state;
obtaining real time data from a timer;
obtaining turn-on schedule data from a memory unit;
comparing the real time data and the turn-on schedule data;
generating a turn-on signal from a logic unit if the real time data and the turn-on schedule data are the same; and
changing a state indicator data stored in a register according to the turn-on schedule data.

13. The method for turning on a system automatically according to claim 12, wherein the turn-on schedule data includes at least two time events.

14. The method for turning on a system automatically according to claim 12, wherein the real time data is obtained from the timer only if the state of the main power is the turn-off state.

15. The method for turning on a system automatically according to claim 12, further comprising performing a program according to the state indicator data after the step of comparing the real time data and the turn-on schedule data.

16. The method for turning on a system automatically according to claim 15, wherein the main power is a main power of a player apparatus, and the program is a playing program.

17. The method for turning on a system automatically according to claim 16, wherein the player apparatus comprises an ATM, a digital signage, a kiosk or a gaming machine.

18. The method for turning on a system automatically according to claim 12, wherein the main power is a main power of a player apparatus.

19. The method for turning on a system automatically according to claim 18, wherein the player apparatus comprises an ATM, a digital signage, a kiosk or a gaming machine.
